(19) United States
(12) Patent Application Publication
(10) Pub. No.: US 2024/0137365 A1
(43) Pub. Date: Apr. 25, 2024

(54) Managing Trusted User Devices Via Silent Push Notifications

(71) Applicant: Capital One Services, LLC, McLean, VA (US)

(72) Inventors: Erik Neighbour, Arlington, VA (US); Jason Pribble, McLean, VA (US); Maneill Parekh, Washington, DC (US)

(21) Appl. No.: 17/972,842

(22) Filed: Oct. 24, 2022

(51) Int. Cl. H04L 9/40

(52) U.S. Cl. CPC H04L 63/102; H04L 63/0876; H04L 63/18

(57) ABSTRACT

Methods, systems, and apparatuses for managing the preauthorization of user devices to access resources in one or more remote servers are described herein. Preauthorized user devices may access the resources without repeatedly going through multiple-factor authentication processes. Data for such preauthorized user devices may be maintained in a list of trusted user devices. To determine whether user devices are still eligible to be included in the list of trusted user devices, silent push notifications may be sent to the user devices. The silent push notifications may be configured not to cause outputs of any displays at the user devices or modify any current displays. Based on deliverability statistics that indicate whether the user devices acknowledged the silent push notifications, user devices may be kept in the list of trusted devices or removed from the list of trusted devices.

### FIELD OF USE

Aspects of the disclosure generally relate to the management and/or monitoring of trusted user devices that are preauthorized to access resources in one or more servers. More specifically, aspects of the disclosure relate to monitoring trusted user devices by sending silent push notifications to the trusted user devices.

### BACKGROUND

Users may often be required to authenticate themselves and/or their user devices when they access various resources provided by and/or stored in remote servers with their user devices. Such resources may include, for example, cloud storage, downloadable media or content, subscription programming, emails, financial services, social media platforms, virtual learning platforms, personal networks, work networks, and/or other platforms or networks. Example authentication methods may include single-factor authentication (e.g., a username in combination with a password, a personal identification number, or a code), two-factor authentication (e.g., single-factor authentication in combination with a one-time code sent to an application, a phone number, or device that can receive a push notification or short message service, fingerprint, facial recognition, voice recognition, or location or behavior-based information), multi-factor authentication, biometric authentication (e.g., fingerprints, palms, retina, face, and voice recognition), certificate-based authentication, token-based authentication, challenge handshake authentication (e.g., changer provided to a user device), and/or other authentication methods.

It may be inconvenient or annoying for a user to manually authenticate himself and/or his user device via one or more authentication methods each time the user desires to access a particular resource. Accordingly, a particular user device owned and/or often used by a given user may be authenticated for that particular resource at some initial point in time, and the user device may be added as a trusted user device to a list of trusted user devices. The user devices included in the list of trusted user devices may be preauthorized to access the particular resource. The trusted user devices may access the particular resource without authentication or single-factor authentication. However, the user may later decide not to use the trusted user device anymore, or the trusted user device may become inoperable or get stolen, lost, or given away.

The aspects described herein generally improve the quality, efficiency, and security of the management of trusted user devices by monitoring trusted user devices in a list of trusted user devices and removing user devices that are no longer eligible to be included in the list of trusted devices.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

There may be a need for systems and techniques that remove preauthorization for user devices that are no longer associated with the particular user and/or eligible to be included in the list of trusted user devices.

Aspects described herein relate to maintaining a list of trusted user devices authorized to access one or more resources. User devices may be added to the list of trusted user devices based on one or more authentication methods (e.g., single-factor authentication using authentication credentials such as user name and password, two-factor authentication, multi-factor authentication, etc.). Aspects described herein additionally and/or alternatively relate to monitoring user devices in the list of trusted user devices by causing a push notification service to send silent push notifications to the user devices. The silent push notifications may be periodically sent to the user devices. Additionally, or alternatively, silent push notifications may be sent to the user devices based on a determination that the user devices have not accessed the resources for a threshold time or that an application used for accessing the resources has been uninstalled from the user devices. The silent push notifications may be configured to not cause outputs of any additional displays at the user devices or modify any current displays at the user devices. The silent push notifications may comprise one or more queries for the user devices, such as whether an application used by the user devices to access the resources is still present in the user device, which user account is being used to access the resources, physical locations of the user devices, etc.

Responses to the silent push notifications may indicate whether the user devices have acknowledged the silent push notifications (e.g., via deliverability statistics of the silent push notifications). Responses to the queries in the silent push notifications may be further received from the user devices. The user device may be kept in the list of trusted devices if the deliverability statistics indicate that the user device acknowledged receipt of the silent push notifications and/or responded to queries included in the silent push notifications.

A user device may be removed from the list of trusted devices and denied access to the resources if the deliverability statistics indicate that the user device did not acknowledge the receipts of the silent push notifications and/or did not respond to queries included in the silent push notifications. Additionally and/or alternatively, a user device may be removed from the list of trusted devices if the queries indicate that an application for accessing the resources was uninstalled from the user device, the application was storing information about a user account different than one previously used by the user device to access the resources, or the application was not storing information about a user account that was previously stored by the application and used to access the resources. The process of removing a user device from a list of trusted user devices may be further based on analyzing additional data associated with the user device, such as the user device being in two or more different physical locations over a time period, accessing one or more untrusted Uniform Resource Locators (URLs), executing one or more untrusted applications, providing global positioning system (GPS) coordinates from one or more untrusted locations, and/or associated with a quantity of purchase transactions that satisfies a threshold quantity.

These features, along with many others, are discussed in greater detail below.

### BRIEF DESCRIPTION OF THE DRAWINGS

The present disclosure is described by way of example and is not limited to the accompanying figures in which similar reference numerals indicate similar elements and in which:

FIG. 1 shows an example of an environment where one or more aspects described herein may be implemented.

FIG. 2 shows a flow chart of an example process for providing authorization for a user device to access resources.

FIG. 3 shows a flow chart of an example process for monitoring trusted user devices via push notifications.

FIG. 4 shows a flow chart of an example process for sending push notifications to trusted user devices by a push notification server.

FIG. 5 shows a flow chart of an example process for processing push notifications by a user device.

FIG. 6 shows an example computing device according to one or more aspects of the disclosure.

### DETAILED DESCRIPTION

In the following description of the various embodiments, reference is made to the accompanying drawings, which form a part hereof, and in which is shown by way of illustration, various embodiments in which aspects of the disclosure may be practiced. It is to be understood that other embodiments may be utilized, and structural and functional modifications may be made without departing from the scope of the present disclosure. Aspects of the disclosure are capable of other embodiments and of being practiced or being carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, aspects discussed herein may comprise an authentication service that manages requests from user devices to access resources provided by and/or stored in one or more servers. The authentication service may require that a user device requesting access to a particular resource be able to authenticate itself by performing one or more authentication processes selected by the authentication service. Such authentication processes may comprise single-factor authentication, two-factor authentication, multi-factor authentication, biometric authentication, certificate-based authentication, token-based authentication, challenge handshake authentication, and/or other authentication methods.

Additionally, and/or alternatively, the authentication service may maintain a list of trusted user devices comprising user devices that requested access to the resources at an earlier point in time by providing the authentication credentials needed to satisfy the authentication processes used by the authentication service. The authentication credentials may be associated with the users of the user devices (e.g., user name, password, biometric information, etc.) or the user devices (e.g., internet protocol addresses, certifications for the user devices, media access control addresses, etc.). After authorizing the user device to access the resources at an earlier point in time, the authentication service may preauthorize the user devices to access the resources at later points in time by adding the user devices to the list of trusted user devices maintained by the authentication service. Preauthorization may comprise the user device accessing the resources without providing any authentication credentials to the authentication service if the authentication processes require single-factor authentication, certificate-based authentication, token-based authentication, etc. Additionally, or alternatively, preauthorization may comprise the user device providing authentication credentials for single-factor authentication if the authentication processes require two-factor, multiple-factor, biometric, and/or challenge handshake authentication.

After receiving preauthorization from the authentication service and/or being included in the list of trusted devices maintained by the authentication service, the user device may become ineligible to be a trusted device by the authentication service and/or be included in the list of trusted user devices maintained by the authentication service. A user device may become ineligible if, for example, the user device is no longer associated with the user involved with the preauthorization at the initial point in time. For example, the user may no longer use the preauthorized user device, or the user device may become inoperable, get stolen or lost, or be given away. Even if the user still owns the user device, a user device may become ineligible if an application that was used by the user device to access the resources was uninstalled from the user device, a user account that was previously used by the user device to gain preauthorization is no longer being used by the user device, and/or it is determined that that the user devices are performing activities that disqualify the user device from being treated as a trusted user device. Such activities may include the user device being in a physical location that is different than the physical location where preauthorization was granted, requesting access from different physical locations over a period of time, accessing one or more untrusted Uniform Resource Locators (URLs), executing one or more untrusted applications, providing global positioning system (GPS) coordinates from one or more untrusted locations, and/or associated with a large quantity of purchase transactions, etc. Existing authentication services may not monitor the user devices after adding the user devices to the list of trusted user devices and/or keep user devices in the list of trusted user devices that are no longer eligible to be included in the list of trusted user devices.

The authentication service described herein may address the drawbacks of existing authentication that may keep user devices in the list of trusted user devices that are no longer eligible to be included in the list of trusted user devices. The authentication service described herein may improve the functioning of computing devices by improving the functioning and security of servers providing and/or storing resources by monitoring user devices included in the list of trusted user devices and removing user devices that are no longer eligible to be included in the list of trusted user devices. The authentication service described herein may monitor user devices included in the list of trusted devices to determine whether they have become ineligible to be included by sending silent or non-silent push notifications to the user devices and/or analyzing the deliverability statistics of the sent push notifications. The authentication service may additionally and/or alternatively determine the eligibilities of the user devices based on data gathered about the user devices via queries sent with the push notifications and/or other data gathered for the user devices.

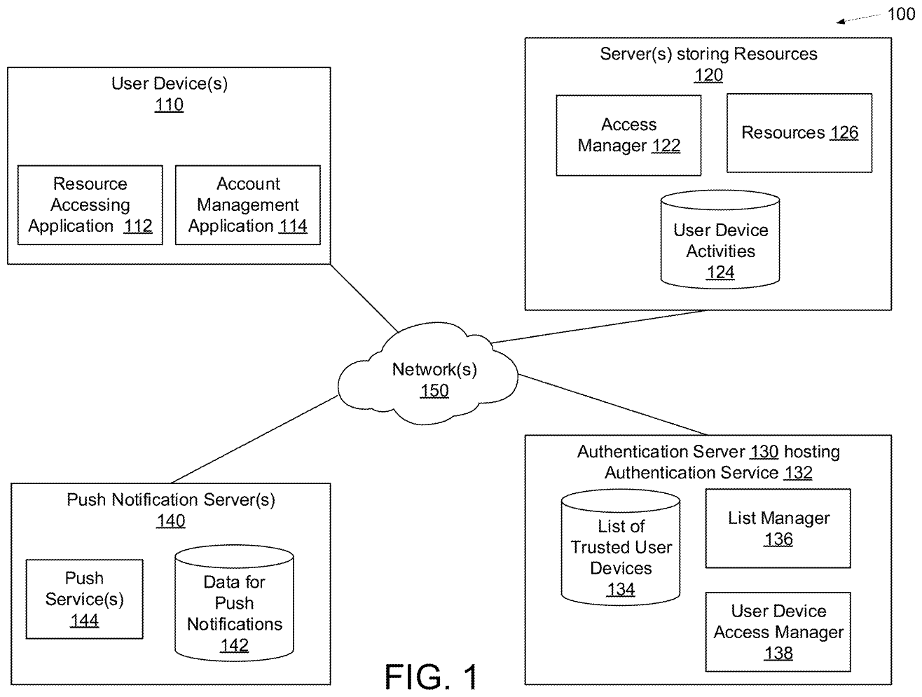

FIG. 1 illustrates an architectural level schematic of an environment 100 in which an authentication service with one or more aspects described herein may be implemented. The environment 100 includes a network 150, a user device 110, a push notification server 140, a server 120 storing resources that may be accessed by applications installed or present in the user device 110 and other user devices, and/or an authentication server 130 hosting an authentication service 132. While only one example user device and one example push notification server are shown in FIG. 1, multiple user devices may request access to the resources stored in the server 120, and multiple push notification servers may be in communication with the authentication server 132 and the user devices. In some examples, the server 120 storing the resources may host its own authentication service. The authentication service 132 hosted by the authentication server 130 and/or the server 120 may manage requests from the user device 110 to access the resources stored in the server 120 via various authentication methods preferred by the authentication service. Authenticating a user device comprises conditionally providing access to resources stored on the server 120 based on whether the user device has been authenticated, and that determination might be made based on different authentication methods, such as single-factor, multiple-factor, or two-factor authentication. The authentication service 132 may also manage the preauthorization of the user device 110 to access the resources without undergoing any additional authentication processes or just a single-factor authentication.

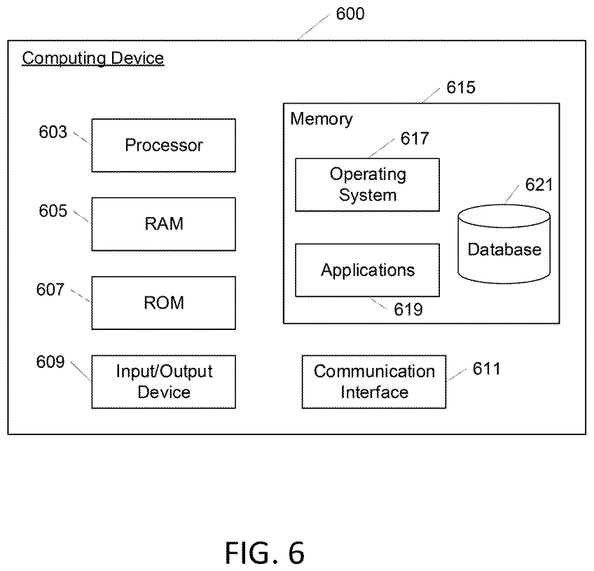

The communications between the user device 110, the push notification server 140, the server 120, the user device 110, and/or the authentication server 130 may occur over a variety of networks 150, e.g., private networks, VPN, or Internet, and may use appropriate application programming interfaces (APIs) and data interchange formats, e.g., Representational State Transfer (REST), JavaScript™ Object Notation (JSON), Extensible Markup Language (XML), Simple Object Access Protocol (SOAP), Java™ Message Service (JMS), and/or Java Platform Module System. Some of the communications may be encrypted. The networks 150 may be a LAN (local area network), a WAN (wide area network), and/or telephone network (Public Switched Telephone Network (PSTN), Session Initiation Protocol (SIP), wireless network, point-to-point network, star network, token ring network, hub network, Internet, inclusive of the mobile Internet, via protocols such as EDGE, 3G, 4G LTE, Wi-Fi, 5G, and WiMAX.) It will be appreciated that the network connections shown in the environment 100 are illustrative, and any means of establishing a communications link between the different devices (e.g., the user devices 110, the push notification servers 140, the servers 120, the user devices 110, and/or the authentication server 130) may be used. Any of the devices and/or systems described herein may be implemented, in whole or in part, using one or more computing systems described with respect to FIG. 6. The data transferred to and from various devices in the environment 100 may include secure and sensitive data, such as confidential documents, customer personally identifiable information, and account data. Therefore, it may be desirable to protect the transmissions of such data using secure network protocols and encryption, and/or to protect the integrity of the data when stored on the various computing devices. Any databases included in FIG. 1 may include, but are not limited to, relational databases, hierarchical databases, distributed databases, in-memory databases, flat file databases, XML databases, NoSQL databases, graph databases, and/or a combination thereof.

The server 120 may store resources 126 that may be accessed by the user device 110 and/or other user devices. Such resources may include, for example, cloud storage, downloadable media or content, subscription programming, emails, financial services, social media platforms, virtual learning platforms, financial platforms, personal networks, work networks, online games, video games, massively multiplayer online games, virtual workout platforms, virtual travel platforms, websites, e-commerce platforms, virtual learning environments, collaborative virtual environments, and/or other digital platforms and/or networks. The resources 126 may be stored in different forms (e.g., graphics, video, text, data, transactions, and/or other representations). The resources 126 stored in the server 120 may be accessed by the user device 110 via the networks 150. The server 120 may comprise an access manager 122 that receives requests from the user device 110 and other user devices to access the resources 126. The access manager 122 may direct the requests to the authentication service 132 hosted by the authentication server 130 or any authentication services hosted by the server 120. Additionally, the server 120 may comprise software and/or hardware components to retrieve resources (e.g., blogs, posts, webpages, virtual scenes, virtual environment, financial information, etc.) requested by an authorized user device and/or initiate delivery of the requested resources.

Additionally, the server 120 may comprise a database 124 for storing activities performed by the user device 110 and other user devices related to the resources 126. Example activities may include financial transactions, purchases, posts, actions in games, blogs, motions, and/or other user activities. The database 124 may also comprise records of the physical locations of the user devices when the activities were performed.

The example user device 110 may comprise a desktop computer, a computer server, a mobile device such as a laptop computer, a tablet computer, a smartphone, any other types of mobile computing devices, and/or any other type of data processing device. The user device 110 may comprise a software application 112 (also referred to as an “app”) that requests access to the resources 126 stored in the server 120. The server 120 may send the requested resources 126 to the application 112. The application 112 may cause a display and/or output of the requested resources to users of the user device 110. The user device 110 may download the application 112 from an application server that provides various applications for downloading. In some examples, the application 112 may be a web browser.

A user may create and/or use a user account to access the resources 126. This user account may be associated with any access request initiated by the user with the user device 110 via the application 112 and/or activities associated with viewing or manipulating the resources 126. The application 112 may be configured to store the user account used by the user device to access the resources 126 in the server 120. Additionally, or alternatively, the user device 110 may comprise an application 114 that manages user accounts for different applications 112 and/or stores information (e.g., authentication credentials such as username and password) used by the application 112 to access the resources 126. The application 114 may store profile information for a user account, including a unique account identifier identifying the user account, personal information, username, password, email address, home address, credit card information, banking information, etc. Example application 114 for managing user accounts may include Google Account Manager, iCloud Account Management, Android Account Manager, etc.

An example push notification server 140 may comprise a push service 144 configured to generate push notifications. A push notification may be a mechanism for pushing messages from the push notification server 140 to an application (e.g., the application 112 for accessing the resources) on a user device (e.g., the user device 110). Example push service 144 may comprise Apple Push Notification Service developed by Apple Inc. of Cupertino, California, Android Cloud to Device Messaging Service developed by Google Inc. of Mountain View, California, Microsoft Push Notification Service developed by Microsoft of Redmond, Washington, or the Blackberry Push Service developed by BlackBerry Limited of Waterloo, Canada. In some examples, the user device 110 or an application (e.g., application 112) present in the user device may register with the push service 144 to receive push notifications from the push service 144. During registering with the push service 144, a unique device identifier may be assigned to the user device, and/or a unique application identifier may be assigned to the application registering with the push services 144. The push service may use the unique device identifier and/or application identifier to send push notifications to the user device and/or the application.

Push notifications may be received by the user device 110 regardless of whether any particular application is currently running. Some push notifications may include a message that may be displayed to users of the user device 110. Such push notifications might be referred to as non-silent push notifications because they cause some output that might alert one or more users of the user device 110. Additionally and/or alternatively, the push notifications sent by the push service 144 may be silent push notifications. A silent push notification, when received by a user device, might not cause the output of additional displays at the user device or modification (e.g., addition or removal of information) of current displays at the user device. The silent push notifications and/or non-silent push notifications generated by the push service 144 may comprise one or more queries. The queries may wake up one or more applications and/or collect information, including the state of the application, such as whether the application is still present in the user device, user accounts being used by the application, activities performed by the users of the user device via the application, the location of the user device, and other data about the user device and/or the application. Push notifications may be associated with one or more applications but need not be received by those applications, and those applications need not be running.

The user device and/or one or more applications may receive a silent and/or non-silent push notification and send a signal or message to the push service acknowledging the push notification. Additionally, and/or alternatively, the user device and/or one or more applications may perform any queries included in the push notifications and send responses to the queries to the push service 144. In some examples where one or more applications are no longer present in the user device 110, the user device 110 may send a signal to the push service 144 that the application has been uninstalled or has failed to send any signal or acknowledgment about the push notification to the push service 144 or responses to queries indicated in the push notification. Data for sent push notifications to the user devices, any queries sent with the push notifications, and/or responses for the push notifications and/or the queries may be stored in the database 142 for storing data for push notifications.

The authentication server 130 may host an authentication service 132 that may be configured to regulate requests from the user device 110 and other user devices to access the resources 126 in the server 120. In some examples, the authentication server 130 may be a part of the server 120 storing the resources 126. In other examples, the server 120 may host its own authentication service. The authentication service 132 may include software components referred to herein as a list manager 136 and a user device access manager 138. The authentication service 132 may also include a database 134 storing a list of trusted user devices.

The list of trusted user devices, which might be stored in the database 134, may contain information regarding the user devices (e.g., the user device 110) that have been preauthorized to access the resources 126. The information in the database 134 may include, but is not limited to, identifiers for the user devices (e.g., MAC addresses, IP addresses, etc.), any unique identifiers assigned to the user devices for push notification services, application identifiers for the applications 112 installed in the user devices 110 to access the resources 126, physical locations of the user devices when the user devices were added to the list of trusted user devices, the contact information of users associated with the user devices (e.g., address, phone number, email addresses, etc.), user accounts used by the user devices to access the resources 126, etc.

The user device access manager 138 may be configured to manage requests from the user device 110 and other user devices to access the resources 126. The user device access manager may receive the requests directly from the user device 110 or the access manager 122 from the server 120. The request may comprise authentication credentials for a single-factor authentication (e.g., a username and a password). Alternatively, and/or alternatively, the request might not be accompanied by any authentication credentials. The user device access manager 138 may determine whether a user device requesting access to the resources 126 is included in the list of trusted user devices stored in the database 134. If the user device is not included in the list of trusted user devices and/or not preauthorized to access the resources 126, the user device access manager 138 may select to authenticate the user device via various authentication methods, such as single-factor authentication, certificate-based authentication, token-based authentication, two-factor authentication, multiple-factor authentication, biometric authentication, and/or challenge handshake authentication. If the user device is included in the list of trusted user devices and/or preauthorized to access the resources 126, the user device access manager 138 may allow the user device to access the resources 126 without going through additional authentication or just undergoing a single-factor authentication.

The list manager 136 may be configured to monitor the user devices included in the list of trusted user devices in the database 134 to determine whether the user devices are still eligible to be included in the list as a trusted device. The list manager 136 may remove a user device from the list of trusted user devices if the list manager 136 determines that the user device is no longer eligible to be included in the list of trusted user devices. Additionally, the list manager 136 may be configured to keep a user device in the list of trusted user devices if the list manager 136 determines that the user device is still eligible to be included in the list of trusted user devices.

The list manager 136 may determine whether the user device 110 is still eligible (and, e.g., should remain on the list of trusted user devices) by collecting data about the user device 110 and/or the application 112 present in the user device 110 to access the resources 126 via non-silent and/or silent push notifications sent by the push services 144 in the push notification server 140. For example, the list manager 136 may determine whether a user is still using the user device 110 and/or whether the application 112 is still present in the user device 110 by requesting to send push notifications to the user device 110. Additionally, the list manager 136 may send a request to the push service 144 to include one or more queries about the user device 110 and the application 112 present in the user device 110 for accessing the resources 126. The push service 144 may send push notifications to the user device 110 on behalf of the authentication service 132 and/or the list manager 138 and/or send deliverability statistics of the push notifications to the list manager 136, where the deliverability statistics indicate whether the user device 110 and/or the application 112 have sent an acknowledgment for the sent push notifications. The push service 144 may also send responses to any queries included in the push notifications to the list manager 136. The list manager may determine whether the user device 110 is still eligible to be included in the list of trusted user devices based on data indicated in the deliverability statistics and/or responses to the queries in the push notifications.

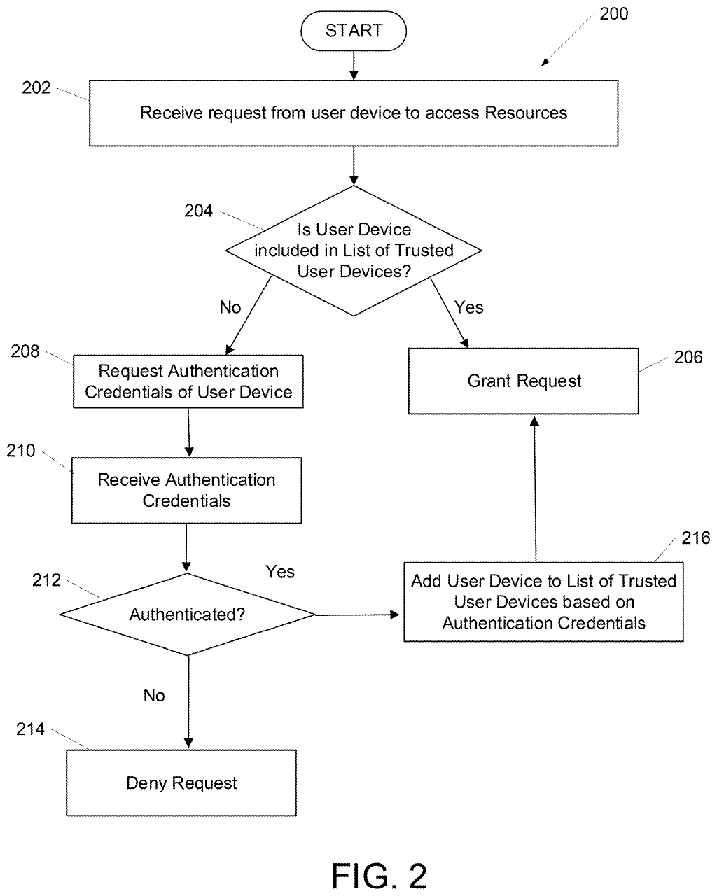

FIG. 2 shows a flowchart 200 of an example method for processing a request from a user device (e.g., the user device 110) to access resources (e.g., resources 126 stored in the server 120). Some or all of the steps of the flowchart 200 may be performed by an authentication service (e.g., by the user device access manager 138 of the authentication service 132 provided by the authentication server 130 or the server(s) 120 storing the resources 126). In some examples, the actions in the flowchart 200 may be performed in different orders and with different, fewer, or additional actions than those illustrated in FIG. 2. Multiple actions may be combined and/or divided into sub-actions in some implementations. A computing device may comprise one or more processors and memory storing instructions that, when executed by the one or more processors, cause the performance of one or more steps of FIG. 2. One or more non-transitory media may comprise instructions that, when executed by one or more processors, cause the performance of one or more steps of FIG. 2.

The flowchart 200 begins at step 202, when a request may be received from a user device (e.g., the user device 110) to access resources (e.g., resources 126) stored in and/or provided by one or more servers (e.g., the server(s) 120 storing resources 126). The request may be sent by an application installed on the user device (e.g., the application 112) or a web browser installed on the user device. The request may comprise authentication credentials corresponding to one or more users of the user device, such as information about a user account associated with the users and used for accessing the resources. The authentication credentials may comprise information for a single-factor authentication (e.g., a username or email in combination with a password, a personal identification number, or a code). Additionally, and/or alternatively, the request may comprise a device identifier for the user device (e.g., Internet Protocol (IP) addresses, Media Access Control (MAC) addresses, any unique identifier assigned to the user device for push notification services), an application identifier for the application requesting to access the resources, and/or information about the physical location of the user device when the user device sent the request.

At step 204, the authentication service may determine whether the user device of step 202 is preauthorized to access the resources by being included in the list of trusted user devices maintained by the authentication service (e.g., a list of trusted user devices stored in the database 134). The list of trusted user devices may include, but is not limited to, identifiers for preauthorized user devices, such as the MAC addresses, IP addresses, any unique identifiers assigned to the preauthorized user devices for push notification services, application identifiers for the applications installed in the preauthorized user devices to access the resources, physical locations of the preauthorized user devices when the user devices were added to the list of trusted user devices, etc. The authentication service may determine whether the user device of step 202 is preauthorized to access the resources by checking if the device identifier or application identifier received at step 202 is included in the information stored in the list of trusted user devices. As another example, the authentication may determine that the user device of 202 is preauthorized if the physical location of the user device received at step 202 is similar to the physical location of the user device stored in the list of trusted devices.

At step 206, if the authentication service determines that the user device of step 202 is preauthorized to access the resources, the authentication service may grant the request by the user device to access the resources. Granting the request may comprise allowing the user device of step 202 to access the resources without undergoing any authentication method. Alternatively, granting the request may comprise allowing the user device of step 202 to access the resources after undergoing a single-factor authentication (e.g., authentication via a user name and/or password).

At step 208, if the authentication service determines that the user device of step 202 is not preauthorized to access the resources, the authentication service may request the user device of step 202 to provide authentication credentials such that the authentication service may authenticate the user device by performing one or my authentication methods preferred by the authentication service. For example, the authentication service may use single-factor authentication to authenticate user devices and send a request to the user device for a username and/or a password, a personal identification number, or a code associated with a user account for accessing the resources. For two-factor authentication, the authentication service may request authentication credentials required for a single-factor authentication and, for example, a one-time code sent to the application requesting access to the resources or the user device. The authentication service may request a push notification server (e.g., the push notification server 140) to send the one-time code as a push notification or a short message service. In some examples, the authentication service may request biometric authentication credentials, such as fingerprint, facial or voice recognition. In some examples, the authentication service may request a certificate or a token stored by the user device and used by the authentication service to authenticate the user device. In some examples, a challenge may be sent to the user device, and the user device may be requested to complete the challenge and send back the result of the challenge as the authentication credentials.

At step 210, authentication credentials requested from the user device at step 208 may be received. At step 212, the authentication service may attempt to authenticate the user device based on the received authentication credentials. If the authentication service is not able to authenticate the user device based on the received authentication credentials, the authentication service may deny the request from the user device to access the resources at step 214. The authentication may send a message to the user device indicating the denial.

At step 216, if the authentication service is able to authenticate the user device based on the received authentication credentials, the authentication service may add the user device to the list of trusted user devices maintained by the authentication service as a trusted device. Adding the user device to the list of trusted user devices may comprise modifying the list to include a device identifier associated with the user device, an application identifier for the application requesting access, and/or the current physical location of the user device. After adding the user device to the list of trusted user devices, step 206 may be performed, where the authentication service may grant the request by the user device to access the resources.

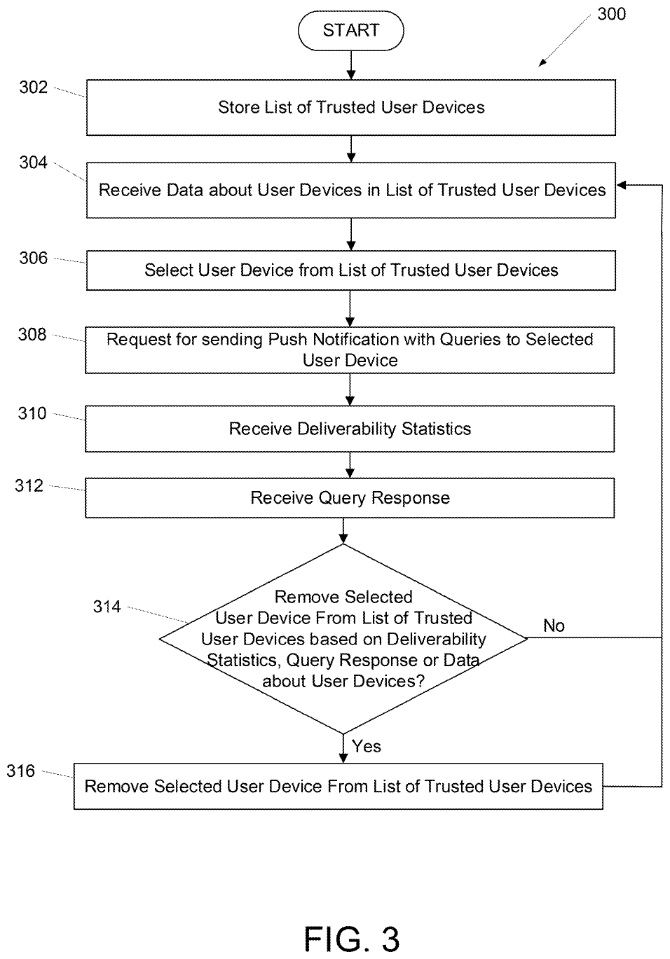

FIG. 3 shows a flow chart of an example process for monitoring trusted user devices via push notifications. FIG. 3 shows a flowchart 300 of an example method for monitoring user devices in a list of trusted user devices (e.g., the list of trusted user devices stored in the database 134). Some or all of the steps of the flowchart 300 may be performed by an authentication service (e.g., by the list manager 134 of the authentication service 132 provided by the authentication server 130 or the server(s) 120 storing the resources 126). In some examples, the actions in the flowchart 300 may be performed in different orders and with different, fewer, or additional actions than those illustrated in FIG. 3. Multiple actions may be combined and/or divided into sub-actions in some implementations. A computing device may comprise one or more processors and memory storing instructions that, when executed by the one or more processors, cause the performance of one or more steps of FIG. 2. One or more non-transitory media may comprise instructions that, when executed by one or more processors, cause the performance of one or more steps of FIG. 2.

The flowchart 300 begins at step 302, where the authentication service stores a list of trusted user devices (e.g., stores the list of trusted user devices in the database 134). The list of trusted user devices may comprise user devices preauthorized to access resources (e.g., resources 126 stored in the server 120). User devices may be added to the list of trusted user devices after undergoing one or more authentication processes, such as single-factor authentication, certificate-based authentication, token-based authentication, two-factor authentication, multiple-factor authentication, biometric authentication, and/or challenge handshake authentication.

At step 304, the authentication service may receive data about the user devices included in the list of trusted user devices. The authentication service may receive the data from servers storing resources (e.g., the servers 120). The data may comprise information about activities performed by the user devices related to the resources. Example activities may include financial transactions, purchases, accessing one or more untrusted Uniform Resource Locators (URLs), executing one or more untrusted applications, global positioning system (GPS) coordinates of the user devices while performing the activities, and/or other user activities.

At step 306, a user device may be selected from the list of trusted user devices. A user device may be selected randomly by the authentication service, or at certain predetermined intervals (e.g., once a week, once in two weeks, once a month, etc.). Additionally, or alternatively, the authentication service may select a user device based on the selected user device satisfying one or more selection criteria. The selection criteria may comprise determining that the selected user device has not accessed the resources for a threshold period of time (e.g., a week, two weeks, a month, etc.), receiving an indication that an application (e.g., the application 112) used for accessing the resources has been uninstalled from the user device, receiving an indication that the most recent access request is from a physical location different that then one when the user device was added to the list of trusted user devices, receiving an indication the most recent request is associated with a user account different than the one stored in the list of trusted user devices, and/or other selection criteria.

At step 308, the authentication service may send a request to send a push notification to the selected user device of step 306. In some examples, the requested push notification may be a silent push notification when the aim of sending the push notification is to inquire whether the user device is still active or the application is still present in the user device, and inputs from users of the user device are not needed. In other examples, the requested push notification may be a non-silent push notification when inputs from users of the user device are needed (e.g., a pop-up notification that requests the user to confirm his or her identity). The request may be sent to a push service (e.g., push services 144 stored in the push notification servers 140). In some examples, the selected user device or an application installed in the selected user device and used to access resources may be registered to receive push notifications with one or more push services. Information about the push services (e.g., internet protocol address, weblinks.) may be provided to the authentication service when the user device is added to the list of trusted user devices. The user device and/or the application may be assigned unique identifiers that may be used by the push services to be used as addresses when delivering push notifications to the user device and/or the application. Such unique identifiers may be added to the list of trusted user devices when the user device is added to the list. Sending a request to the push services may comprise sending the unique identifiers to the push services.

The authentication service may send a request to add one or more queries to the push notifications to be sent to the user device. The queries may request the physical location of the user device (e.g., global positioning system coordinates), information about any user account frequency used by the application (e.g., the application may have a “Remember Me” or another application in the user device may manage user accounts for different applications and/or store information authentication credentials used by the different applications), records of activities performed by the user device and/or the application, such as accessing one or more untrusted URLs, untrusted locations, financial or purchase transactions performed by the user device and/or the application, and/or other user device or application related data.

At step 310, the authentication service may receive deliverability statistics from the push service. The deliverability statistics may indicate whether the application has acknowledged the push notification (e.g., silent or non-silent) within a time period after the push notification was sent (e.g., five minutes, ten minutes, an hour, a day, etc.). At step 312, the authentication service may receive responses to queries included in the push notification.

At step 314, the authentication service may determine whether to remove or keep the selected user device in the list of trusted user devices based on the deliverability statistics that were received at step 310, responses to queries that may have been received at step 312, and/or data received about the selected user device at step 306.

Step 314 may be performed by machine learning-based models hosted by the authentication server (e.g., the authentication server 120) hosting the authentication service. Examples of machine learning-based models include natural language processing, regression-based models, neural network-based models, and/or fully-connected network-based models. The machine learning-based models may be trained on suspicious and/or non-suspicious activities of various user devices such that the machine learning-based models may be able to predict whether a particular user device can be trusted or not.

For example, if the deliverability statistics indicate that the application has not sent an acknowledgment for the sent silent push notification within a time period, it may be assumed that the application is no longer present or has been uninstalled from the user device. As the application for accessing the resources is no longer present in the user device, the authentication service may remove the selected user device from the list of trusted user devices.

If the deliverability statistics indicate that the application has sent an acknowledgment for the silent push notification, the authentication service may determine to keep the selected user device in the list of trusted user devices. Alternatively, even if the deliverability statistics indicate that the application has sent an acknowledgment for the sent silent push notification, the authentication service may determine to remove the selected user device from the list of trusted user devices based on the responses to queries that may have been received at step 312, and/or data received about the selected user device at step 306. For example, the authentication service may remove the selected user device if no responses are received for the queries included in the silent push notification.

The authentication service may also remove the selected user device if the user activities data received at step 306 indicates that the selected user devices have been in different physical locations over a time period (e.g., in five different locations within a week, a device might be stolen and moved somewhere new, etc.).

Additionally, or alternatively, the authentication service may also remove the selected user device if responses to the queries indicate when the selected user device responded to the queries, the selected user device was in a different physical location than the one when the selected user device was added to the list of trusted user devices (e.g., the selected user device was in Washington, DC when added to the list of trusted user device but in Houston, TX when the selected user device responded to the queries).

The authentication service may also remove the selected user device if responses to the queries indicate or the user activities indicate that the application is not storing a user account that was previously stored by the application and used to access one or more resources or not storing an account that was used by the application when the user device was added to the list of trusted user devices (e.g., information about a user account stored using “remember me” functionality of the application is no longer available). A new account may suggest the theft or sale of the user device, or the user device being associated with a new user. Additionally, the authentication service may remove the selected user device if responses to the queries indicate that the application is storing information about a user account that is different than the user account previously used by the application to access the resources or used by the application when the selected user device was added to the list of trusted user devices (e.g., a user account for John Doe was saved using the “remember me” functionality when the selected user device was added to the list of trusted user devices but the responses show that a user account for Jane Smith is being stored by the application now).

The authentication service may also remove the selected user device if responses to the queries indicate or the user activities of the user device indicate that the user device and/or the application have been involved in suspicious activities, such as the user device was accessing untrusted or suspicious Uniform Resource Locators (URLs), the user device was executing untrusted applications, the user device was located in untrusted or suspicious locations, the quantity of purchase or financial transactions recently performed by the user device and/or the application exceeds a predetermined quantity, and/or other suspicious activities.

If the authentication service decides to remove the selected user device at step 314, all information associated with the selected user device is removed or deleted from the list of trusted user devices at step 316, and then step 304 may be performed. If the authentication service decides to keep the selected user device at step 314, step 304 may be performed.

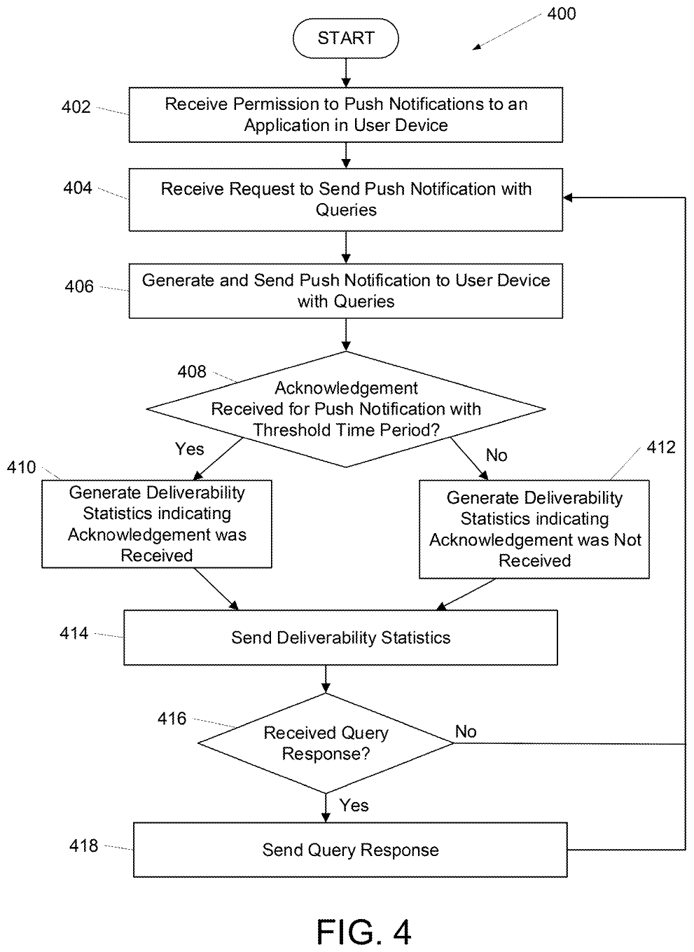

FIG. 4 shows a flow chart 400 of an example process for sending push notifications to trusted user devices in a list of trusted user devices. Some or all of the steps of the flowchart 400 may be performed by a push service (e.g., a push service 144 hosted by the push notification server 140). In some examples, the actions in the flowchart 400 may be performed in different orders and with different, fewer, or additional actions than those illustrated in FIG. 4. Multiple actions may be combined and/or divided into sub-actions in some implementations. A computing device may comprise one or more processors and memory storing instructions that, when executed by the one or more processors, cause the performance of one or more steps of FIG. 2. One or more non-transitory media may comprise instructions that, when executed by one or more processors, cause the performance of one or more steps of FIG. 2.

The flowchart 400 begins at step 402, where a push service (e.g., such as the push service 144) may receive a request from an application (e.g., the application 112 for accessing the resources 126) of a user device to register to receive push notifications facilitated by the push service. The request may be sent by the user device when the application is being installed on the user device and/or a change in settings of the application by a user of the user device. The request may comprise authorization for the push service to send push notifications for the application. Additionally, and/or alternatively, the request may comprise registration information, such as a device identifier for the user device (e.g., internet protocol addresses, media access control addresses, any unique identifier assigned to the user device for push notification services), an application identifier for the application requesting to be registered with the push services, and/or information about any user account associated with the application or the user device.

At step 404, the push service may receive a request from an authentication service (e.g., the authentication service 132 provided by the authentication server 130 or the server(s) 120 storing the resources 126) to send a push notification (e.g., silent or non-silent) to the application of step 402. The request may comprise a device identifier for the user device of step 402 (e.g., internet protocol addresses, media access control addresses, any unique identifier assigned to the user device for push notification services) and/or an application identifier for the application that will receive the push notification.

The request may also include one or more queries in the push notification to be sent to the application. For example, the authentication service may request the physical location of the user device (e.g., GPS coordinates), information about any user account frequency used by the application (e.g., the application may have a “Remember Me” or another application in the user device may manage user accounts for different applications and/or store information authentication credentials used by the different applications). The queries may also request for records of activities performed by the user device and/or the application, such as accessing one or more untrusted URLs, untrusted locations, financial or purchase transactions performed by the user device and/or the application, and/or other user device or application related data.

At step 406, the push service may generate the push notification requested at step 404 and send the push notification to the user device and/or the application. The device identifier and/or the application identifier received at step 404 may be used as addresses when sending the push notification. In some examples, the push notification may be stored by the push service, and the user device may later retrieve the push notification.

At step 408, the push service may determine whether it received an acknowledgment for the push notification sent at step 406. The push service may wait for a time period after the push notification is sent for acknowledgment. The time period may comprise five minutes, ten minutes, fifteen minutes, an hour, three hours, a day, etc. Within the time period, the push service may be configured to retry sending the push notification (e.g., retry every ten minutes within a time period of an hour, retry every hour within a time period of a day).

If an acknowledgment has been received from the user device and/or the application, the push service may generate deliverability statistics that indicate that the user device and/or the application has sent an acknowledgment for receiving the push notification at step 410. If an acknowledgment has not been received from the user device and/or the application, the push service may generate deliverability statistics that indicate that the user device and/or the application has not sent an acknowledgment for receiving the push notification at step 412. At step 414, the generated deliverability statistics of steps 412 or 414 may be sent to the authentication service. At step 416, the push service may determine whether it has received responses to queries included in the push notification sent at step 406. If any responses have been received, the responses may be sent or forwarded to the authentication service at step 418. If no responses have been received at step 416 or after step 418, step 404 may be performed.

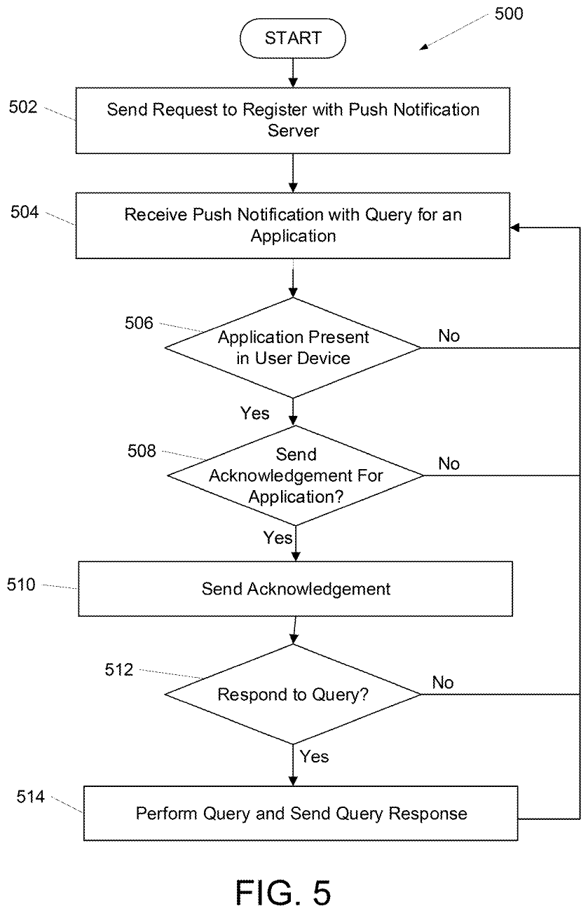

FIG. 5 shows an example method 500 for processing push notifications by a user device (e.g., one of the user devices 110) that is included as a trusted device in the list of trusted devices maintained by an authentication service (e.g., the authentication service 132 hosted by the authentication server 130 and/or any authentication services hosted the servers 120 storing the resources 126). One, some, or all of the steps in the example method 500 may be rearranged or otherwise modified. Steps may be omitted and/or other steps added. A computing device may comprise one or more processors and memory storing instructions that, when executed by the one or more processors, cause the performance of one or more steps of FIG. 2. One or more non-transitory media may comprise instructions that, when executed by one or more processors, cause the performance of one or more steps of FIG. 2.

At step 502 of the example method 500, an application (e.g., the application 112 for accessing the resources 126) of the user device may send a request to register with one or more push services (e.g., the push services 144 hosted by the push notification server 140). The request may be sent when the application is being installed on the user device and/or there is a change in settings of the application by a user of the user device. The request may comprise authorization for the push services to send push notifications to the application. Additionally, and/or alternatively, the request may comprise registration information, such as a device identifier for the user device (e.g., IP addresses, MAC addresses, any unique identifier assigned to the user device for push notification services), an application identifier for the application requesting to be registered with the push services, and/or information about any user account associated with the application or the user device. In some examples, the user device may send a request to register to receive push notifications for multiple applications installed on the user device. In such examples, the registration information includes an application identifier for each of the multiple applications.

At step 504, the user device may receive one or more push notifications for the application registered at step 502 from a push service. The push notifications may be silent or non-silent. Silent push notifications may be configured not to display any information at the user device or change any current display at the user device. Non-silent push notifications may be configured to display messages included in the non-silent push notifications. The push notification may comprise one or more queries the user device may perform in the background without modifying any display at the user device.

In some examples, the push notifications may be stored in the push notification servers by the push service, and the user device may retrieve (e.g., fetches) the push notifications for the application by issuing a request for the push notifications to the push service. The request to the push service may provide a last synchronization date and time (i.e., the last date and time at which the user device retrieved push notifications). The user device may retrieve push notifications issued after the last synchronization date and time.

The push notifications received by the user device may comprise an identifier of the application for which the push notifications were targeted. At step 506, the user device may determine whether the application is still present or installed in the user device. If the application is not present or has been uninstalled, the user device disregards the push notifications, and step 504 may be performed again.

If it is determined that the application is present in the user device, then the user device may forward the push notifications to the application at step 508. At step 510, it may be determined whether the application wants to send an acknowledgment for the received push notification. If the application does not want to send an acknowledgment, the push notification may be disregarded by the user device, and step 504 may be performed again. Otherwise, step 512 may be performed, where an acknowledgment for the received push notification may be sent to the push service.

The push notification received at step 504 may comprise one or more queries. The queries may be requested by an authentication service managing requests by the user device to access resources (e.g., resources 126) stored in one or more remote servers (e.g., the servers 120). The queries may comprise a request for a physical location of the user device, such as the GPS coordinates of the user device. Additionally, the question may comprise a request to indicate whether the application that can be used to access the resources is storing information for a user account that is frequently used to access the resources. For example, the application may have a “Remember Me” functionality that allows a user of the user device to access the resources without re-entering the authentication credentials (e.g., username and password) for the user account. As another example, another application in the user device (e.g., application 114) may manage user accounts for different applications and/or store information (e.g., authentication credentials such as username and password) used by the different applications. The queries may also request records of activities performed by the user device and/or the application, such as accessing one or more untrusted or suspicious URLs, being present in suspicious locations, financial or purchase transactions performed by the user device and/or the application, and/or other user device or application related data.

At step 512, the user device and/or the application may determine whether to respond to the queries included in the push notification. For example, a user of the user device may configure the privacy settings of the device such that the user device or the application is not able to share its physical location or activities. In such an example, the user device and/or the application may decline to respond to the queries, and step 504 may be performed. If the user device and/or the application selected to respond to the queries included in the push notification, then at step 514, the user device and/or the application may perform the queries and send the responses to the queries to the push services.

Turning now to FIG. 6, a computing device 600 that may be used with one or more of the computational systems is described. The computing device 600 may be the same or similar as any one of the user device(s) 110, the server(s) 120, the push notification server(s) 140, and/or the authentication server 130 of FIG. 1. The computing device 600 may include a processor 603 for controlling overall operation of the computing device 600 and its associated components, including RAM 605, ROM 607, input/output device 609, communication interface 611, and/or memory 615. A data bus may interconnect processor(s) 603, RAM 605, ROM 607, memory 615, I/O device 609, and/or communication interface 611. In some embodiments, computing device 600 may represent, be incorporated in, and/or include various devices such as a desktop computer, a computer server, a mobile device, such as a laptop computer, a tablet computer, a smartphone, any other types of mobile computing devices, and the like, and/or any other type of data processing device.

Input/output (I/O) device 609 may include a microphone, keypad, touch screen, and/or stylus through which a user of the computing device 600 may provide input, and may also include one or more of a speaker for providing audio output and a video display device for providing textual, audiovisual, and/or graphical output. Software may be stored within memory 615 to provide instructions to processor 603 allowing computing device 600 to perform various actions. For example, memory 615 may store software used by the computing device 600, such as an operating system 617, application programs 619, and/or an associated internal database 621. The various hardware memory units in memory 615 may include volatile and nonvolatile, removable and non-removable media implemented in any method or technology for storage of information such as computer-readable instructions, data structures, program modules, or other data. Memory 615 may include one or more physical persistent memory devices and/or one or more non-persistent memory devices. Memory 615 may include but is not limited to, random access memory (RAM) 605, read-only memory (ROM) 607, electronically erasable programmable read-only memory (EEPROM), flash memory or other memory technology, optical disk storage, magnetic cassettes, magnetic tape, magnetic disk storage or other magnetic storage devices, or any other medium that may be used to store the desired information and that may be accessed by processor 603.

Communication interface 611 may include one or more transceivers, digital signal processors, and/or additional circuitry and software for communicating via any network, wired or wireless, using any protocol as described herein.

Processor 603 may include a single central processing unit (CPU), which may be a single-core or multi-core processor, or may include multiple CPUs. Processor(s) 603 and associated components may allow the computing device 600 to execute a series of computer-readable instructions to perform some or all of the processes described herein. Although not shown in FIG. 6, various elements within memory 615 or other components in computing device 600, may include one or more caches, for example, CPU caches used by the processor 603, page caches used by the operating system 617, disk caches of a hard drive, and/or database caches used to cache content from database 621. For embodiments including a CPU cache, the CPU cache may be used by one or more processors 603 to reduce memory latency and access time. A processor 603 may retrieve data from or write data to the CPU cache rather than reading/writing to memory 615, which may improve the speed of these operations. In some examples, a database cache may be created in which certain data from a database 621 is cached in a separate smaller database in a memory separate from the database, such as in RAM 605 or on a separate computing device. For instance, in a multi-tiered application, a database cache on an application server may reduce data retrieval and data manipulation time by not needing to communicate over a network with a back-end database server. These types of caches and others may be included in various embodiments, and may provide potential advantages in certain implementations of devices, systems, and methods described herein, such as faster response times and less dependence on network conditions when transmitting and receiving data.

Although various components of computing device 600 are described separately, the functionality of the various components may be combined and/or performed by a single component and/or multiple computing devices in communication without departing from the invention.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, and the like. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid-state memory, RAM, and the like. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a system, and/or a computer program product.

Although the present invention has been described in certain specific aspects, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is, therefore, to be understood that the present invention may be practiced otherwise than specifically described without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A computer-implemented method comprising:
storing, by a computing device, a list of trusted user devices, wherein each trusted user device, in the list of trusted user devices, has been authorized to access one or more resources based on authentication credentials corresponding to one or more users of the trusted user device;
selecting, by the computing device and from the list of trusted user devices, a user device;
causing, by the computing device, a push notification server to send, via a network, a silent push notification to the user device, wherein the silent push notification is not displayed to a user of the user device;
receiving, by the computing device, deliverability statistics, associated with the silent push notification, that indicate whether the silent push notification was received by the user device; and
determining, by the computing device and based on the deliverability statistics, to deny access to the user device to the one or more resources by removing the user device from the list of trusted user devices.

2. The computer-implemented method of claim 1, wherein the selecting the user device is based on a determination that the user device:
has not accessed the one or more resources for a threshold time period; or
has uninstalled an application for accessing the one or more resources.

3. The computer-implemented method of claim 1, further comprising:
selecting, by the computing device and from the list of trusted user devices, a second user device;
causing, by the computing device, the push notification server to send, via the network, a second silent push notification to the second user device;
receiving, by the computing device, second deliverability statistics, associated with the second silent push notification, that indicate whether the second silent push notification was received by the second user device; and
determining, by the computing device and based on the second deliverability statistics indicating that the user device acknowledged receipt of the silent push notification, to keep the second user device in the list of trusted user devices.

4. The computer-implemented method of claim 1, wherein the determining to deny access comprises determining, based on the deliverability statistics, that the user device did not acknowledge receipt of the silent push notification within a predetermined time period.

5. The method of claim 1, wherein the silent push notification comprises one or more queries, and
wherein determining to deny access comprises determining that the user device did not respond to the one or more queries.

6. The method of claim 1, wherein the determining to deny access comprises determining that an application, for accessing the one or more resources, was uninstalled from the user device.

7. The method of claim 1, wherein the determining to deny access comprises determining that the user device being in two or more different physical locations over a time period.

8. The method of claim 1, wherein the determining to deny access comprises determining that an application, installed in the user device and used for accessing the one or more resources, is storing information about a first user account different from a second user account previously used by the user device to access the one or more resources.

9. The method of claim 1, wherein the determining to deny access comprises determining that an application of the user device is not storing information about a user account previously stored by the application and used to access the one or more resources.

10. The method of claim 1, wherein the determining to deny access comprises determining that the user device is one or more of:
accessing one or more untrusted Uniform Resource Locators (URLs),
executing one or more untrusted applications,
providing global positioning system (GPS) coordinates from one or more untrusted locations, or
associated with a quantity of purchase transactions that satisfies a threshold quantity.

11. The method of claim 1, wherein the push notification server comprises Apple Push Notification Service or Google Cloud Messaging.

12. An authentication system comprising:
one or more processors, and
memory storing instructions that, when executed by the one or more processors, cause the authentication system to:
store a list of trusted user devices, wherein each trusted user device, in the list of trusted user devices, has been authorized to access one or more resources based on authentication credentials corresponding to one or more users of the trusted user device;
select, from the list of trusted user devices, a user device;
cause a push notification server to send, via a network, a silent push notification to the user device, wherein the silent push notification is not displayed to a user of the user device;
receive deliverability statistics, associated with the silent push notification, that indicate whether the silent push notification was received by the user device; and
determine, based on the deliverability statistics, to deny access to the user device to the one or more resources by removing the user device from the list of trusted user devices.

13. The authentication system of claim 12, wherein the instructions, when executed by the one or more processors, cause the authentication system to select the user device based on a determination that the user device:
has not accessed the one or more resources for a threshold time period; or
has uninstalled an application for accessing the one or more resources.

14. The authentication system of claim 12, wherein the instructions, when executed by the one or more processors, further cause the authentication system to:
select, from the list of trusted user devices, a second user device;
cause the push notification server to send, via the network, a second silent push notification to the second user device;
receive second deliverability statistics, associated with the second silent push notification, that indicate whether the second silent push notification was received by the second user device; and
determine, based on the second deliverability statistics indicating that the user device acknowledged receipt of the silent push notification, to keep the second user device in the list of trusted user devices.

15. The authentication system of claim 12, wherein the instructions, when executed by the one or more processors, cause the authentication system to determine to deny access comprises determining that:
the user device did not acknowledge receipt of the silent push notification within a predetermined time period;
the user device did not respond to one or more queries indicated by the silent push notification;
an application, installed on the user device and used for accessing the one or more resources, was uninstalled from the user device;
the user device being in two or more different physical locations over a time period;
an application, installed on the user device and used for accessing the one or more resources, is storing information about a first user account different than a second user account previously used by the user device to access the one or more resources;
an application of the user device is not storing information about a user account that was previously stored by the application and used to access the one or more resources;
the user device is accessing one or more untrusted Uniform Resource Locators (URLs);
the user device is executing one or more untrusted applications;
the user device is providing global positioning system (GPS) coordinates from one or more untrusted locations; or
the user device is associated with a quantity of purchase transactions that satisfies a threshold quantity.

16. The authentication system of claim 12, wherein the push notification server comprises Apple Push Notification Service or Google Cloud Messaging.

17. One or more non-transitory computer-readable media storing instructions that, when executed by one or more processors, cause:
storing a list of trusted user devices, wherein each trusted user device, in the list of trusted user devices, has been authorized to access one or more resources based on authentication credentials corresponding to one or more users of the trusted user device;
selecting, from the list of trusted user devices, a user device;
causing a push notification server to send, via a network, a silent push notification to the user device, wherein the silent push notification is not displayed to a user of the user device;
receiving deliverability statistics, associated with the silent push notification, that indicate whether the silent push notification was received by the user device; and
determining, based on the deliverability statistics, to deny access to the user device to the one or more resources by removing the user device from the list of trusted user devices.

18. The computer-readable media of claim 17, wherein the instructions, when executed by the one or more processors, further cause:
selecting, from the list of trusted user devices, a second user device;
causing the push notification server to send, via the network, a second silent push notification to the second user device;
receiving second deliverability statistics, associated with the second silent push notification, that indicate whether the second silent push notification was received by the second user device; and
determining, based on the second deliverability statistics indicating that the user device acknowledged receipt of the silent push notification, to keep the second user device in the list of trusted user devices.

19. The computer-readable media of claim 17, wherein the instructions, when executed by the one or more processors, cause determining to deny access by determining that:
the user device did not acknowledge receipt of the silent push notification within a predetermined time period;
the user device did not respond to one or more queries indicated by the silent push notification;
an application, for accessing the one or more resources, was uninstalled from the user device;
the user device being in two or more different physical locations over a time period;
an application, of the user device and used for accessing the one or more resources, is storing information about a first user account different than a second user account previously used by the user device to access the one or more resources;
an application of the user device is not storing information about a user account that was previously stored by the application and used to access the one or more resources;
the user device is accessing one or more untrusted Uniform Resource Locators (URLs);
the user device is executing one or more untrusted applications;
the user device is providing global positioning system (GPS) coordinates from one or more untrusted locations; or
the user device is associated with a quantity of purchase transactions that satisfies a threshold quantity.

20. The computer-readable media of claim 17, wherein the push notification server comprises Apple Push Notification Service or Google Cloud Messaging.
